(19) United States
(12) Patent Application Publication
(10) Pub. No.: US 2006/0112542 A1
(43) Pub. Date: Jun. 1, 2006

(54) Deep-drawing machine for producing deep-drawn objects, containers, packaging or similar and method for producing objects of this type

(76) Inventor: Karl Nemeskeri, Wien (AT)

Correspondence Address: JACOBSON HOLMAN PLLC, 400 SEVENTH STREET N.W., SUITE 600, WASHINGTON, DC, 20004, US

(21) Appl. No.: 11/328,138

(22) Filed: Jan. 10, 2006

Related U.S. Application Data
(63) Continuation of application No. PCT/AT04/00246, filed on Jul. 9, 2004.

(30) Foreign Application Priority Data
Jul. 11, 2003 (AT) A 1067/2003

(51) Int. Cl. B23P 21/00; B23P 19/00

(52) U.S. Cl. 29/791; 29/711; 29/795

(57) ABSTRACT

The invention relates to a deep-drawing machine or thermoforming machine for producing diverse objects, containers, packaging or similar from thermoformable plastics. In said machine, plastic blanks are placed in retaining devices, in particular in holding presses (1) and the latter can be displaced in relation to the processing stations The retaining devices or holding presses (1) are separated from or independent of one another and the processing stations are situated or positioned along at least two rows or lines, which are in particular parallel.

### BACKGROUND OF THE INVENTION

The present invention relates to a deep-drawing machine or thermoforming machine for the production of deep-drawn objects or articles, containers, packages or the like, from thermoformable plastic sheets or plates, wherein sheet or plate blanks are arranged in fixing means, particularly tenter frames, and movable relative to processing stations, said fixing means being separated and independent from one another.

### PRIOR ART

Deep-drawing machine or thermoforming machines have been known in the art for quite some time and are used for the production of a plurality of articles or objects from thermally formable plastic sheets or plastic plates. Basically, three types of machines are to be distinguished in the deep-drawing technology.

With the first known type of deep-drawing machines or thermoforming machines, sheet blanks or plate blanks are introduced into tenter frames which are fastened to a carrousel-like machine, thus running through provided workings stations. For the production of mass products, large-sized sheet or plate blanks are required. Also required are several processing stations such as, for instance: heating, deep-drawing or forming, hole-punching, stamping out finished products, stacking, etc., which render the conveyor carrousel too large and too heavy to achieve rapid cycle times at an acceptable energy consumption. For this reason, machines of this type are merely used for products to be produced from thick plate blanks, such as e.g. boats, refrigerator doors, toys and the like, but not for the manufacture of mass articles, which are to be produced in large piece numbers at the lowest prices. The processing of thick plastic plates does not allow rapid cycle times anyway, because the heating of the plates and the cooling of the finished parts cannot proceed quickly.

From EP 0 920 975 A, a hot-molding device comprising the straight conveyance of circulating sheet holding frames has become known, which hot-molding device or deep-drawing machine, in addition to a heating station, includes a forming station, a loading station and the like, wherein the sheets to be molded are tentered in tenter or clamping frames. The tenter or clamping frames are movable in a mutually independent manner so as to be adaptable to the respective operating requirements.

From DE 25 18 340 B2, an apparatus for forming plastic plates from thermoformable plastics has become known, which employs a plurality of processing stations arranged in a linearly consecutive manner, such as an inserting station, several heating stations, a forming station and a removing station, wherein the frames in which the plastic plates to be processed are tentered are conducted outside the processing station from the last station back to the first processing station. The individual frames are separated or independent from one another.

The second type of known thermoforming machines is operated by departing from a sheet roller, by pulling the sheeting through four processing stations. At the first station the sheet is preheated, whereupon it is heated to the thermo-forming temperature by contact heating at the second station and, at the same station, is formed and stamped out. At the third station, the shaped parts are separated from the sheeting and fed to finishing. At the fourth station the stamping grid is rolled up. That type of machine is simple in terms of construction and, therefore, cost-effective, furthermore it produces little waste. As a result, that type of machine is widely used, although it exhibits several drawbacks. Thus, it is only able to process plastic sheets, yet no plastic plates. Moreover, it is unable to produce articles having comparatively large heights such as, e.g., yoghurt cups, drinking cups, etc., since the heated sheet needs to be pre-stretched in the forming of such articles. Machines of that kind, however, can neither pre-stretch nor work with positive molds. Nor can the machine produce flat trays or flat containers having U-edges.

A third type of thermoforming machines is operated as the previously described machine by departing from a sheet roller or sheet web, whereby the sheet web is pulled through individual, alignedly arranged processing stations by the aid of a conveying means and, in particular, chains. That type of thermoforming machine works quickly, is able to pre-stretch the sheet during molding, i.e., produce high articles, is able to mold both positively and negatively and produce even trays or containers having U-edges. Yet, also that machine involves disadvantages. That type of thermoforming machine is in fact unable to process plate blanks. Since the mechanisms of the individual processing stations have to be displaceable in the longitudinal direction in order to be able to produce less waste, the structure of the machine is, moreover, relatively complex and expensive. The greatest disadvantage of the machine, however, consists in that the chain conveyor produces considerable sheet waste on both sides of the sheeting. The quantity of the waste occurring on the sheeting sides constitutes a multiple of the side waste occurring in the thermoforming machine previously described as the second type of machine. Nevertheless, that type of machine comprising a chain conveyor is widely used, since it constitutes a universal sheet processing machine, is able to utilize all known types of molding or forming techniques, and the processing stations are expandable in any desired manner.

### SUMMARY OF THE INVENTION

The present invention aims to provide a deep-drawing machine or thermoforming machine, and a method for producing deep-drawn articles, which allow for the production of the most diverse articles and, in particular, mass products from thermoformable plastic sheets or plates even of extreme heights, objects that can only be manufactured by pre-stretching processes or positive deep-drawing techniques and even such articles having U-edges. Moreover, the machine is to operate with extremely little waste and little energy input, and the number of processing stations is to be expandable in any desired manner.

To solve this object, the invention provides a thermoforming machine for the production of deep-drawn articles, containers, packages or the like, which is characterized in that processing stations are arranged or positioned along at least two, particularly parallelly extending, rows or lines. By the fixing means being separated and independent from one another, it is feasible to minimize the sheet scrap occurring on the edges of the fixing means and to operate in a cost-effective and economic as well as material-saving manner. Due to the fact that, in addition, the processing stations are arranged or positioned along at least two, particularly parallelly extending, rows or lines, the cycle time of the device can be remarkably reduced while, at the same time, achieving extreme energy savings and short cycle times. And by the fixing means being configured as tenter frames not fixedly connected with the machine, individual size adjustments of the fixing means to the sheet blanks to be processed are also feasible so as to allow the sheet blanks to be further minimized. By tentering the sheet blanks or plate blanks in tenter frames, it is feasible to minimize the scrap occurring on the edges of the fixing means and, hence, operate in a material-saving manner. Due to the fact that the tenter frames may, furthermore, be made of light metal or synthetic material and are firmly connected neither with the machine nor with one another, it is feasible to keep the conveying times of the tenter frames to the individual processing stations very short with little energy input, thus causing the machine to operate cost-effectively and economically with short cycle times.

By the fixing means being movable along slide bearings or guides made, in particular, of synthetic materials, the rapid, low-noise and energy-saving guidance of the fixing means along the parallelly extending lines or rows is feasible so as to achieve additional energy savings over known carrousel systems, where the whole systems must be moved in a disadvantageous manner. It is, furthermore, possible by the fixing means being movable along slide bearings or guides, to rapidly and readily exchange wear parts without involving long stop periods of the machine, thus providing an additional increase in the efficiency of the deep-drawing machine.

According to a further development of the deep-drawing machine according to the present invention, tensioning bars may be adjustably arranged on opposite frame elements of the fixing means. By such an adjustable arrangement of tensioning bars, it is feasible, on the one hand, to adapt the tensioning bars to any desired sheet blank sizes and, on the other hand, to adapt the machine to plastic sheets strongly expanding during heating and, hence, being subject to strong volume enlargements, without cumbersome replacement or retensioning means by simply adjusting the tensioning bars so as to cause the sheet blanks to be safely and reliably held flat merely readjusting the tensioning bars. Such a retensioning of the heated sheet blanks, in particular, ensures extremely reliable and dimensionally stable deep-drawing while safely avoiding the formation of wrinkles and other defects caused by the sagging of the sheet blanks. In addition, such a configuration enables the continuous adjustment of the deep-drawing machine to any blank width and length, thus enabling the rapid and reliable manufacture of a plurality of different shapes and articles on one and the same machine without having to exchange machine parts.

According to a further development of the invention, the device is designed in a manner that the number of fixing means exceeds the number of processing stations. Such a design enables the machine to be controlled in such a manner that the excess fixing means will always be on the transfer site between the individual rows of processing stations so as to ensure the rapid and reliable operation of the entire deep-drawing machine.

According to a further development of the invention, the tenter frames are attached to two slide ledges, this unit being translationally movable within and between the rows or lines as previously described. This further development of the invention means that the length of the slide ledges may always be the same irrespective of whether the largest or smallest tenter frame provided is attached thereto.

The processing stations of the deep-drawing machine may comprise a sheet blank inserting station, at least one heating station, at least one deep-drawing station and at least one finishing station as well as a removing station. Equipped in this manner, the machine can be readily adapted to various requirements merely by adding a modular element of a processing station in which a tenter frame including an inserted sheet blank can be processed.

According to a preferred further development, at least one stamping station is included among the processing stations. By providing a stamping station, the finished deep-drawn articles can be seamlessly and Pointlessly stamped out of the tenter frames, thus providing streamlined articles without sharp edges or edge beads.

According to a further development of the invention, the device is preferably further developed such that the fixing means or tenter frames are translationally movable within or between the rows or lines of processing stations. By providing a number of tenter frames that corresponds with the number of processing stations, plus two tenter frames each located at the transferring stations between to relatively arranged rows or lines, the arrangement will be sufficient, thus enabling the realization of an extremely simple structural arrangement of the machine besides a rapid and cost-effective mode of operation of the machine.

The fixing means or tenter frames are movable along the parallelly arranged rows or lines in a manner presently known in the art. Due to the fact that the tenter frames, and also the slide ledges, can be made of light metal or synthetic material, they are cost-effective to produce, and since they are firmly connected neither with one another nor with the machine, they are readily and rapidly exchangeable at a mold or tool exchange, thus adding further to the efficiency of the thermoforming machine.

The processing stations of this thermoforming machine may comprise a sheet or plate blank inserting station, at least one heating station, a deep-drawing or forming station, at least one stamping station as well as a waste removing station. It is, however, possible to adapt the machine to any requirement by the addition of any desired number of modular elements of additional processing stations.

### SHORT DESCRIPTION OF THE DRAWINGS

In the following, the invention will be elucidated further by way of the accompanying drawings. Therein:

FIG. 1 schematically illustrates the tenter frames, which are fastened to slide ledges;

FIG. 2 illustrates the configuration of the tenter frames; and

FIGS. 3 to 12 are examples of a thermoforming machine including eight stations.

### PREFERRED EMBODIMENTS

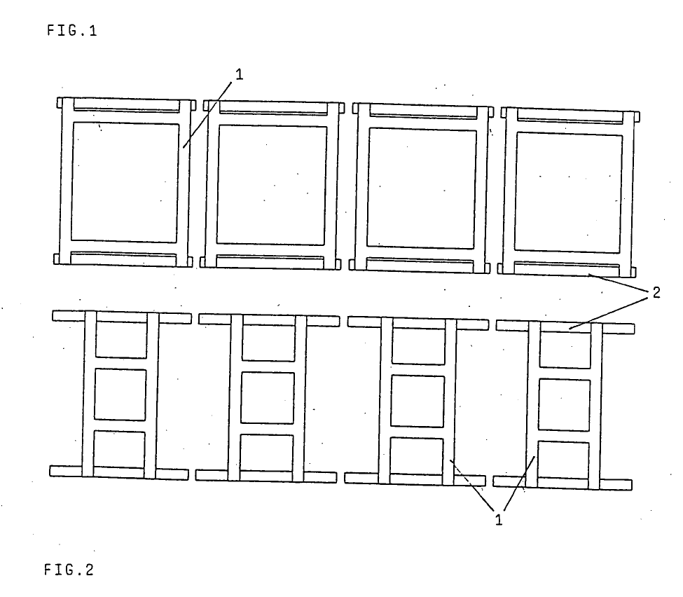

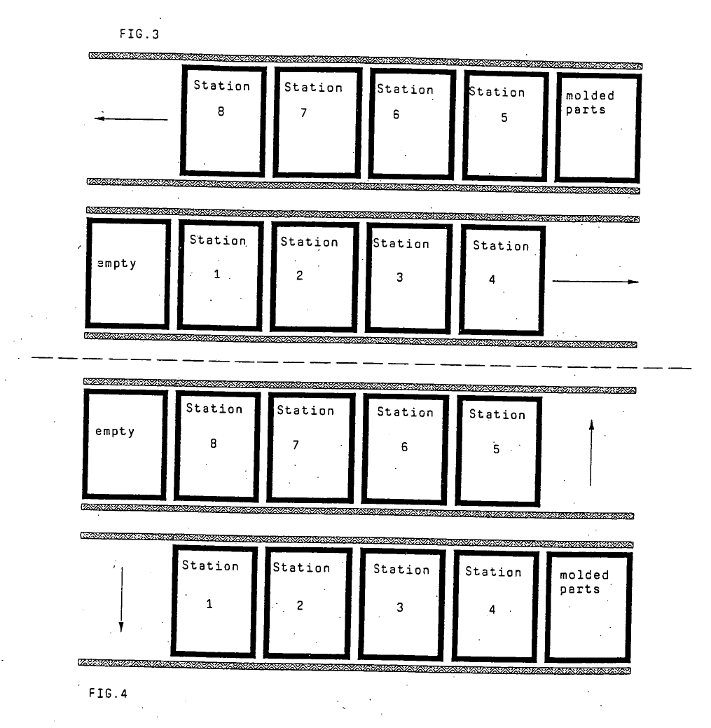

FIG. 1 depicts a thermoforming machine or deep-drawing machine comprising four large tenter frames 1 running on slide ledges 2. By such an arrangement of the tenter frames, the distance between the individual processing stations will always be the same both with large tenter frames 1 as in accordance with FIG. 1 and with small tenter frames as in accordance with FIG. 2, it being thereby feasible to attach the mechanisms of the individual processing stations not movably as in machines with chain conveyors, but fixedly so as to allow for a substantial reduction of the production costs of the machine.

The example outlines a thermoforming machine according to FIGS. 3 to 12, which includes eight stations, yet this does not mean that the number of processing stations is limited to eight according to the invention. In FIG. 3, the eight stations are denoted by numbers as follows: Station 1 is the inserting station, where a sheet or plate blank is inserted into the tenter frame 1; station 2 is the first heating station, where the plastic blank is preheated; station 3 is the second heating station, where the plastic blank is completely heated to thermoformable temperature; station 4 is the forming station, where the plastic blank is deep-drawn or formed; station 5 is the first stamping station, where holes are punched into the finished parts, or where the finished parts are stamped out partially if stamping out in two stages is more appropriate; station 6 is the second stamping station for stamping out the finished parts that have still remained suspended in the blank, thus reaching the consecutively arranged processing station; station 7 is the stacking station, where the finished parts are broken out of the plastic blanks and stacked; station 8 is the removing station, where the stamping grid is removed from the tenter frame 1. In this context, it should be noted that the machine according to the invention might also be designed to comprise a stamping station where the finished parts are punched. In that case, the finished parts will not remain suspended on the blank, but fall through to be stacked.

The method and mode of operation of the machine will be described below. FIGS. 3 and 4 illustrate the machine in such a manner that the number of fixing means or tenter frames 1 corresponds with the number of processing stations—eight in the instant case—plus two. FIG. 3 shows the state of the tenter frames 1 of a machine already in operation, i.e., prior to the beginning a new cycle. After the beginning of said cycle, the following happens: the five tenter frames 1 in the first row—the lower row in the drawing—are displaced in the sense of the arrow. At the same time, also the five tenter frames 1 in the second row are displaced in the sense of the arrow. FIG. 4 shows the tenter frames 1 in their new positions after each tenter frame 1 has reached a new processing station. Thus, for instance, the empty tenter frame 1 is now at the first station and, for instance, the tenter frame 1 carrying molded parts, which was in the transfer position prior to the beginning of the cycle, is now at station 5. As soon as the displaced tenter frames 1 have reached their new locations, all of the eight stations will start operating at the same time. Before the processing of the plastic blanks has been completed at all of the eight stations, the tenter frames 1 pushed out of the processing stations are transferred to the other row, hence the tenter frames 1 carrying the molded parts are moved from the first into the second row and the empty tenter frame 1 is moved from the second into the first row. As soon as a cycle is completed, i.e. when all of the eight processing stations are ready, the locations of the tenter frames 1 are again those of FIG. 1, and a new cycle may commence.

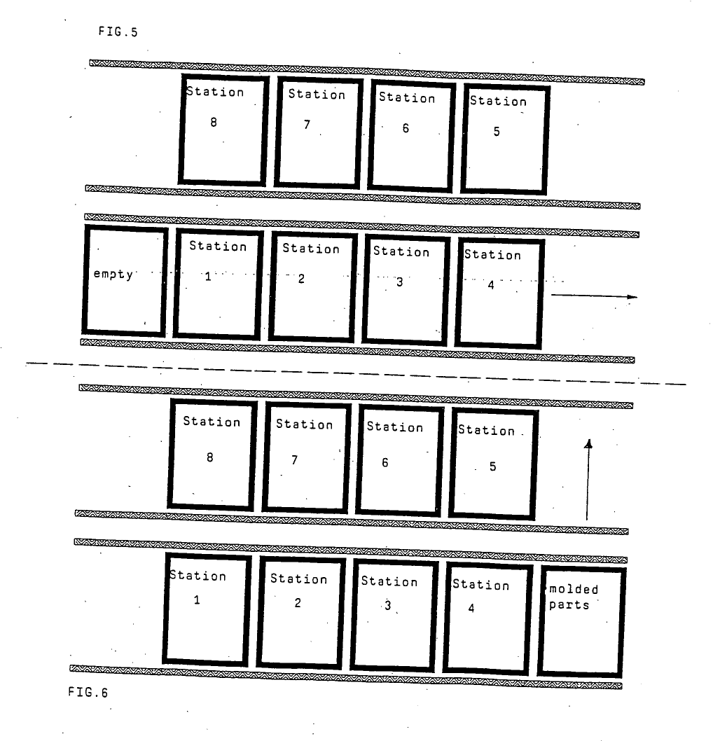

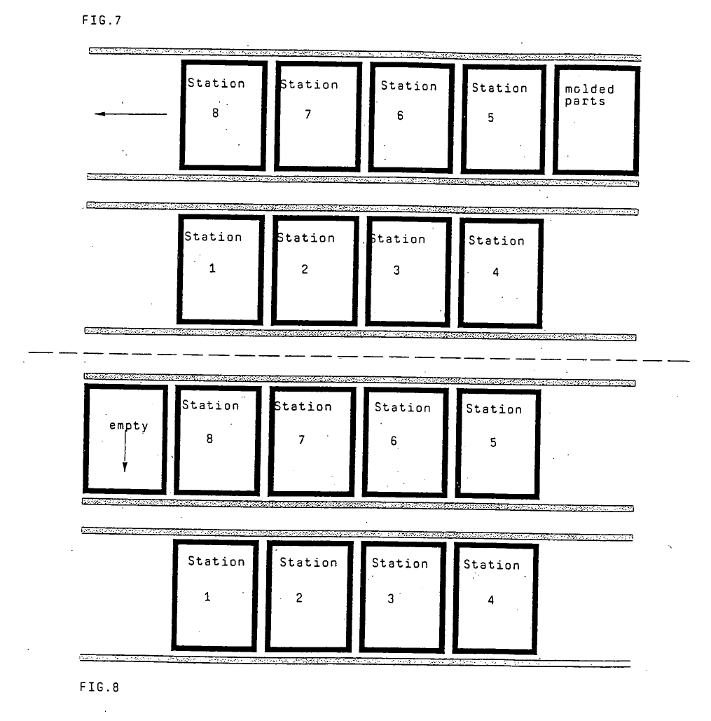

According to a further development of the invention, the device may also be designed such that the number of fixing means or tenter frames 1 corresponds with the number of processing stations plus only one. Consequently, the sequence of a working cycle of the machine will be different. Again, a machine comprising eight processing stations similar to those described above is chosen as an example; yet, the overall number of tenter frames 1 will be 8+1 in this case, which means nine pieces in total. To simplify the description, a cycle time of 2 seconds is fully arbitrarily assumed as an example. FIG. 5 depicts the nine tenter frames 1 before the start of a cycle. FIG. 6 shows the locations of the tenter frames 1 after 0.3 seconds, after having displaced the five tenter frames 1 from the first row—the lower one in the drawing. Each of the five tenter frames 1 is now in another position and the processing stations 1 to 4 start operating. Nothing has changed at the processing stations 5 to 8. The tenter frame 1 carrying the shaped parts is being conveyed from the first row into the second row at the same time as the processing stations 1 to 4 start operating, reaching the position in the second row as illustrated in FIG. 7 at 0.8 sec. from the beginning of the cycle. After a short waiting time, exactly at half-time of the cycle, i.e. at 1.0 sec., the tenter frames 1 in the second row are going to be displaced. The time at the end of said conveyance is 1.3 sec. No change in the first row, where the processing stations 1 to 4 are located. FIG. 8 shows the positions of the tenter frames 1 at a cycle time of 1.3 sec. Now, the processing of the plastic blanks will immediately also commence at processing stations 5 to 8, with the tenter frame 1 denoted as empty in the instant case being conveyed to the first row. The cycle time at which that empty tenter frame 1 has arrived in the first row is 1.8 sec. After a cycle time of 2 secs., the position of the tenter frame 1 is again as illustrated in FIG. 5. Naturally, the cycle time of the second row likewise amounts to 2 secs., shifted only by half the cycle time, and a new cycle may commence.

In connection with the structural configuration of the invention, according to which the fixing means are separated and independent from one other and the processing stations are arranged along at least two, particularly parallelly extending, rows or lines, it will be favorable if the number of processing stations is identical in each row in order to be able to avoid an asymmetric mode operation of the device. It is, in fact, simpler and cheaper if the transfer positions are in one line. This is, however, no precondition for the invention, it is only that the transfer of a tenter frame 1 into a different row will be readily and reliably effected, for instance, by a robot if the new location is not in one line. If the processing stations provided constitute an odd number, an expert of the deep-drawing technology will, however, choose another, equally possible solution by arranging one station as an empty station. This means, in fact, no shortening of the cycle times, i.e., no decreased output of the machine, but only that one tenter frame 1 more will be required. Yet, there is the option to additionally set up a processing station for any eventuality.

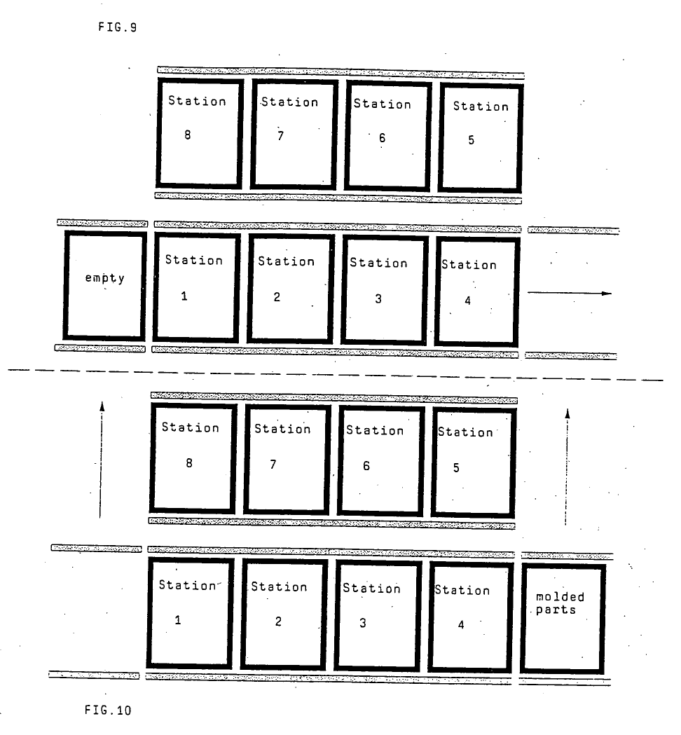

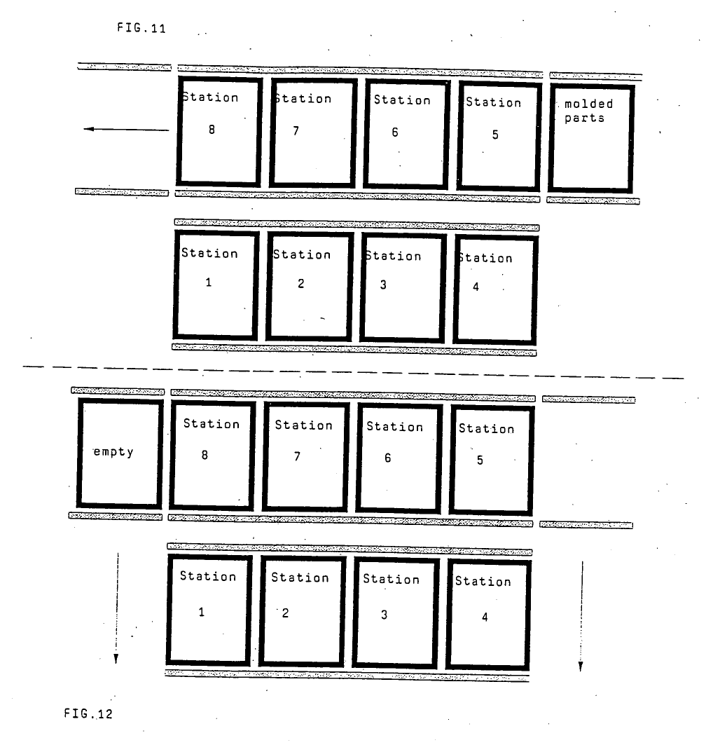

The transfer of the tenter frames 1 pushed out of the processing stations, into the other row is effected in any known manner, for instance by a robot gripping the tenter frame 1 and placing it in the second line. According to a further development of the invention, a favorable method will be presented and described in the following. The tenter frames 1 mounted on the slide ledges 2 slide on synthetic shoes or rollers, preferably on rails. According to a further development of the invention, these rails are divided, as is apparent from FIGS. 9 to 12. For the sake of simplicity, the sequence of an operating cycle will be described below fully arbitrarily by way of example. FIG. 9 shows the eight tenter frames 1 at the eight processing stations. As is apparent from the drawing, the rail pair on which the slide ledges 2 slide or roll with the tenter frames 1 mounted thereon is continuous for the four stations of each row and divided on either side for the transfer position. The rail pair for the tenter frame 1 to be transferred is required on both sides, yet only once and not for every row. As an example, 2.0 seconds are again chosen for a cycle as previously described. FIG. 9 depicts the five tenter frames 1 prior to and at the beginning of a cycle. After the start of the cycle, the five tenter frames 1 are displaced in the sense of the arrow, and at 0.3 sec. the conveyance is completed, with the new situation being shown in FIG. 10. As soon as this conveyance has been completed, i.e. at 0.3 sec., the processing stations 1 to 4 start operating and the conveyance of the short rail pair with the tenter frame 1 mounted thereon will commence together with the conveyance into the second row, of the empty rail pair located on the other end of the row. At 0.8 sec. after the beginning of the cycle, the two rail pairs have reached the second row as illustrated in the drawing of FIG. 11. At 1.0 sec., i.e. exactly at half the cycle time, a cycle will start in the second row by the five tenter frames 1 being displaced in the direction indicated by the arrow. Through this conveyance, the tenter frame 1 carrying the shaped parts, thus, reaches station no. 5, while the emptied tenter frame 1 passes from station no. 8 onto the short rail pair. When this conveyance has been completed, the time is 1.3 sec. according to the selected example. At that time, stations 5 to 8 will start operating and the short conveying rail pair will start moving to the first row, as is apparent from FIG. 12. The time is 1.8 sec. when the two rail pairs, the one with the empty tenter frame 1 and the other one empty, have arrived in the first row. Now, the same positions of the tenter frame 1 and the conveying rail pairs as at the beginning has been reached, cf. FIG. 9. After the cycle time has elapsed, i.e. after 2 sec., a new cycle may start. Processing stations nos. 5 to 8 will naturally terminate the cycle at 3.0 secs., having started the cycle at 1.0 sec.

This further development of the invention offers the advantage that fewer rails are required and the conveyance of a tenter frame 1 plus rails is simpler and more cost-effective than it would be, if the tenter frame 1 were to be lifted off the rail pair at first, conveyed subsequently, and again deposited on a rail pair.

If a machine comprising an odd number of processing stations were to be produced, the method comprising divided rails may also be used; yet only partially on one side of the processing row.

According to another further development of the invention, a method is provided, which eliminates the frequently necessary and cumbersome, i.e. expensive, device for the extra preheating of the sheeting. There are, in fact, plastic sheets or plates that expand particularly strongly during heating, for instance: polypropylene. Thus, so large a “stomach” may form after the heating station as to cause wrinkles during forming. To prevent this, the sheeting is preheated in a separate device, with the expansion of the sheeting partially occurring prior to its introduction into the thermoforming machine. Any further expansion in the heating station(s) will no longer be much of a problem. The invention solves this problem in that, firstly, at least two stations are in any event provided for the preheating of the sheet or plate blanks. At the first station, contact heating is provided such that the plastic sheet or plate is pressed against a heated plate made of light metal or steel or a copper alloy and whose surface is treated or prepared so that hot plastic sheets or plates will no longer adhere to, but rather slide on the same, by a foam-like or similarly resilient heat-resistant plastic plate or sheet likewise offering a good sliding surface. At that preheating station, the tenter frame 1 is slightly opened as the plastic blank is being heated, so as to allow the plastic blank to freely expand. At the end of the heating period, the tenter frame 1 is closed while the strongly preheated sheet or plate reaches the second heating station. There, this procedure may be repeated and the plastic blank may reach a third heating station to be heated completely, or the plastic blank is immediately brought to the full forming temperature already in the second heating station. Whichever method the skilled artisan will choose depends on the sheet or plate thickness and also on the desired cycle time. By providing this method, the application of a separate device is obviated and the thermoforming machine according to the invention has become particularly cost-effective.

1-6. (canceled)

7. A deep-drawing machine or thermoforming machine for the production of deep-drawn or thermally formable articles such as containers, packages or the like, from thermoformable plastic sheets or plates, wherein plastic blanks are arranged in fixing means, particularly tenter frames, and movable relative to processing stations comprised of an inserting station, at least one heating station, a forming station, at least one stamping station, a finished parts removing station and a waste removing station, wherein said fixing means are separated and independent from one another, said processing stations are arranged or positioned along at least two, particularly parallelly extending, rows or lines, and a machine cycle comprises the clock-controlled use of all of said processing stations.

8. The machine according to claim 7, wherein the fixing means or tenter frames are translationally movable within or between the rows or lines of processing stations.

9. The machine according to claim 7, wherein the number of fixing means or tenter frames exceeds the number of processing stations.

10. The machine according to claim 7, wherein differently large fixing means or tenter frames are arranged on equally long slide ledges.

11. The machine according to claim 7, wherein divided rail pairs are arranged for the translational movements of the fixing means or tenter frames.

12. The machine according to claim 7, wherein the fixing means or tenter frames are opened in the preheating phase.
